(19) United States
(12) Patent Application Publication
(10) Pub. No.: US 2006/0020531 A1
(43) Pub. Date: Jan. 26, 2006

(54) Risk return presentation method

(76) Inventors: David C. Veeneman, Lincolnshire, IL (US); Elizabeth K. Veeneman, Lincolnshire, IL (US)

Correspondence Address: David G. Rosenbaum;ROSENBAUM & ASSOCIATES, P.C., Suite #380, 650 Dundee Road, Northbrook, IL, 60062, US

(21) Appl. No.: 11/186,051

(22) Filed: Jul. 21, 2005

Related U.S. Application Data
(60) Provisional application No. 60/589,589, filed on Jul. 21, 2004.

(51) Int. Cl. G06Q 40/00

(52) U.S. Cl. 705/35

(57) ABSTRACT

A system and computer-implemented method for graphical display of risk and return information of an investment mix or an investment portfolio based upon investment asset classes from which the investor selects a mix and assigns desired weights for each asset class in the mix. The investor's risk tolerance is dynamically assessed by graphically presenting different risk and return scenarios for a plurality of investment mixes calculated from the selected asset classes and assigned weights. Once a user selects an investment mix commensurate with the investor's risk tolerance, the investor may then enter financial data corresponding to actual investments, transactions of which are tracked in the system and performance evaluated based upon the investor's targeted risk and return values and benchmark funds consistent with the investors investment mix.

### CROSS-REFERENCE TO RELATED APPLICATIONS

This application is related to and claims priority to prior-filed U.S. Provisional Patent Application Ser. No. 60/589,589 filed Jul. 21, 2004.

### BACKGROUND OF THE INVENTION

The present invention relates generally to methods of evaluating risks and returns of investment portfolios and investment mixes based upon historical performance and application of predictive algorithms to forecast future risks and returns. More specifically, the present invention relates to a computer-implemented method of presenting risk-return analyses for a continuum of investment mixes in an interactive graphical environment. The present invention also calculates expected performance of an investment mix and the performance of an investment portfolio. This is useful in two respects: (1) A do-it-yourself user can tell whether his portfolio is performing to targets; and (2) a user who relies on an advisor can monitor the advisor's performance the same way.

As used in this application the terms “investment mix” and “mix” are intended to connote possible combinations of investments based upon user-selected asset classes and any constraints placed upon the selected asset classes. Examples of applicable constraints include maximum or minimum weight percentages assigned to each asset class.

The terms “investment portfolio” or “portfolio” are intended to mean a specific investment mix selected by a user which is to be used to determine the asset classes in which funds will be invested and the weight percentages of each asset classes within the portfolio.

The term “asset class” as used herein is intended to mean a fundamental investment type, and includes, e.g., cash, government bonds, large-cap stock funds, mid-cap stock funds, etc. as opposed to the individual funds or fund families.

Traditionally, there has been a large gap between the investment portfolio management tools available to institutional investors and those available to non-institutional investors. However, many of the fundamental principals of institutional investing are equally applicable to non-institutional investors. Institutional investing focuses much of its attention on controlling portfolio investing. The most obvious risk is that a company in which one has invested defaults on its obligations. This ‘non-systematic’ risk can be virtually eliminated by spreading one's investments among a number of companies and types of investments. The major risk remaining is what lay people call ‘market risk’ and professionals call ‘volatility’ or ‘systematic risk’. This risk is the danger that the market for an ‘asset class’ (a broad category of investments) will fall, leading to unrealized losses in a portfolio. This risk can be avoided only by eliminating one's exposure to capital market investments, such as stocks and bonds. However, the risk can be controlled by diversifying among several different asset classes and controlling the weight of each asset class in a portfolio. In other words, by controlling the asset allocation of a portfolio, an investor can generally fix the portfolio to the specific level of risk he or she is willing to bear.

Institutional investors generally employ investment advisors who use complex computer models, known as “portfolio optimizers” or “efficient frontier programs” to determine the asset allocations of their portfolios. These computer models optimize return for risk; that is, they calculate the asset class percentages that can be expected to a) provide a specific level of investment risk, and b) provide the highest return available at that specific level of risk. Some optimizers optimize risk for return; that is, they calculate the asset allocation that provides the lowest risk for any given level of return. A simple example will illustrate the process: Take five asset classes; cash, bonds, large US stocks, large foreign stocks, and smaller US stocks. These asset classes can be combined in a nearly infinite variety of combinations. Some of these combinations (such as 99% cash, 1% bonds) will have very low risk and a low expected return over the long run. Others (such as 100% smaller US stocks) will have very high risk, and a correspondingly higher long-run expected return. Others will fall in between. There are any number of possible portfolio combinations along a continuum between the most conservative to the most aggressive risk. Selecting one of these combinations provides a mechanism for an investor to select a point along the continuum consistent with that person's risk level and obtain a reasonable degree of assurance of the risk and return that may be expected over the short and long runs.

Portfolio optimization is not widely available to individual investors. It is generally considered too complex to be understood by lay people, and impractical, in that the services of an expert are required to set up and interpret the model. A number of attempts have been made over the years to bring portfolio optimization to individual, or ‘retail’ investing. Heretofore, however, none of these attempts has yielded a system readily capable of use by lay people.

When possible portfolios are arrayed along a risk continuum, there may be several possible portfolio mixes at each point along the risk continuum. However, even though each portfolio has the same risk, each does not offer the same return. The combinations that provide higher returns are said to be more ‘efficient’ than those with lower returns, in the sense that they provide a higher return at the same level of risk.

There is a need, therefore, for an investment portfolio risk-return analysis and modeling tool suitable for non-institutional investors to assist in their portfolio management.

### SUMMARY OF THE INVENTION

Thus, in accordance with the present invention, in addition to providing a risk continuum and investment mixes ordered along the risk continuum, the present invention also provides an investment mix optimizer which performs calculations that have the effect of arranging possible investment mixes by their level of risk, then selecting the most efficient mix at each point along the risk spectrum based upon return. Thus, the investor needs only to decide what level of risk is acceptable; the optimizer will return a mix that provides that level of risk and assures the highest possible expected return for that specific risk level.

Conventional methods of assessing an investor's risk tolerance have been short risk quizzes or questionnaires. However, such evaluative risk tests are generally unreliable in that investors tend to answer the questions on these quizzes the way they ‘should’ be answered, and consequently overstate their risk tolerance. Moreover, in conventional risk-return assessment, risk and return are typically expressed as a percentage return and standard deviation. Such statistics are usually non-intuitive and, therefore, difficult to understand by most lay people.

In order to render risk-return information in a more understandable form, the present invention presents risk as the likely range of a return around its arithmetic mean value. This range is presented graphically, both as percentages and as dollar amounts. The inventive method also calculates an “expected recovery period” statistic that measures the expected time required for a user-selected portfolio to recover from a given loss. This statistic is presented as the number of years one can reasonably expect to wait for a portfolio to recover to its break-even point after suffering a significant loss. To further aid in achieving a simple user interface and straight-forward graphical display, the present invention presents historical returns in tabular format, accompanied by a histogram superimposed on the risk-return chart described above.

It is an objective of the present invention to employ what is termed a “direct risk assessment method.” The present invention achieves a risk assessment which is direct in that the investor is presented a set of mixes, preferably between 25-250 investment mixes, most preferably between 50 and 100 investment mixes, each of which are individually selectable and displayable. The portfolios are arranged on a risk line, and the investor can scroll among mixes by moving a slider control along a continuum line from conservative to aggressive. As each mix is displayed, the expected return range for that mix is displayed. The investor can also view the range for a user-selectable period of time, for example from one to twenty years. It is desirable, however, that a default period of time be set at one year so that the investor focuses on a one-year earnings range, which will typically be the widest (most volatile) range for any mix. If for a selected mix, the user should desire to investigate more aggressive or more conservative mixs based upon the indicated return range, the user may adjust the slider bar selection accordingly until a mix compatible with the user's risk tolerance is selected. The last mix within the risk tolerance represents the maximum amount of investment risk the investor is willing to tolerate.

The inventive method is run on computer-based systems to communicate the risk and return characteristics of a set of efficient investment mixes generated using asset allocation methodology. While the inventive presentation method can also be easily adapted for use with paper-based investment materials, in accordance with the preferred embodiment and best mode for practicing the invention, the inventive method is computer-implemented and graphically displayed on an electronic display. The present application describes the inventive method in an exemplary implementation in a personal financial management software package. Those skilled in the art will recognize that while this exemplary embodiment is described, the present invention is not limited nor required to be implemented in a financial management software package and that various aspects of the methodology and functionality are readily segregable from other aspects.

The present invention is built on the principles of asset class investing, the prevalent methodology used by major institutional investors. This approach is based on the premise that over 90% of investment performance is determined by the allocation of a mix's or a portfolio's assets among core investment types. The selection of specific funds within the asset classes, and the timing of purchases and sales, determine the remainder.

The present invention uses a standard methodology to calculate what is commonly known as a “time-weighted rate of return” for investment portfolios, and it uses a measurement tool known as a “weighted composite index” to evaluate the quality of that rate of return, as well as of the risk of the investment mix or investment portfolio.

The rate of return for a given investment mix or portfolio may be calculated in several different ways. In accordance with the preferred embodiments of the present invention, the method of the present invention involves calculation of a time-weighted rate of return for a user's investment mix or portfolio. A time-weighted rate of return isolates the growth in a portfolio that is attributable to the growth of its underlying investments, as opposed to growth due to deposits to the portfolio during the measurement period. Methods for calculating time-weighted rates of return are known in the art, as discussed in Brown, S. J., Kritzman, M. P., Quantitative Methods for Financial Analysis (Institute of Chartered Financial Analysts 1990), at pp. 167-168 (hereinafter referred to as “Brown and Kritzman), which is hereby incorporated by reference for purposes of a method for calculating time-weighted rates of return.

Once a return has been calculated for a given investment portfolio or investment mix, the method of the present invention compares the calculated return against the composite of several market indices in order to determine whether the portfolio tracked the market during the evaluation period, outperformed the market during that period, or underperformed the market during the period.

Investment portfolios and investment mixes are typically comprised of one or more investment funds. In an asset allocation method of investing, investment finds are selected so that each represents a fundamental type of investment, also known as an “asset class”. As a non-limiting example, a portfolio may be developed using the asset allocation method and might consist of the funds in Table I, each of which represents the indicated asset class in the adjacent column:

TABLE I

| Fund | Asset Class |
|---|---|
| Vanguard Prime Money Market Fund | Cash |
| Vanguard Inter-Term Treasury Inv Fund | Government Bonds |
| Vangaurd 500 Index Fund | Large Cap U.S. Stocks |
| Vangaurd Developed Markets Index Fund | Large Cap Int'l. Stocks |
| Vangaurd Mid-Cap Index Fund Inv | Mid-cap U.S. Stocks |

In the foregoing example, the funds chosen were, by and large, index funds. The reason is that index funds generally mirror the performance of the asset classes they represent better than actively managed funds. In addition, index funds generally outperform most actively managed funds, once the impact of fees is taken into account. However, the present invention is not limited in its use to index funds and may be used with equal facility with actively-managed funds.

Each fund in a mix or portfolio has a certain weight, which is defined as the balance of the fund, divided by the balance of the overall portfolio. A $10,000 fund in a $50,000 portfolio has a 20% weight in the portfolio. In the asset allocation method of portfolio or mix construction, asset class weights are typically established by use of a mean-variance optimizer. A mean-variance optimizer is typically a computer program which finds optimal fund weights for various levels of investment volatility.

The performance of a fund is generally evaluated by comparison to the performance of a market index, which is generally referred to as the fund's benchmark. For example, the performance of a large-cap U.S. stock fund for a specific period of time is generally compared to the performance of the Standard & Poor's 500 Index for that same period of time. The Standard & Poor's 500 Index (‘the S&P 500’) is generally accepted as the best performance measurement of the overall market for large-cap U.S. stocks. Thus, it is a fair benchmark for funds that invest in that type of stocks. By comparing a particular fund's performance to that of the index, we can easily determine whether the fund outperformed or underperformed the overall market.

The first step in evaluating fund performance is to calculate a rate of return for the portfolio. There are several different ways in which a rate of return can be calculated. The present invention calculates a time-weighted rate of return, which is the generally accepted method of calculating return for performance evaluation. See, e.g, Brown & Kritzman. The time-weighted methodology filters out the effects of contributions and withdrawals on the growth of the portfolio; the growth reported is isolated to the actual growth of the underlying investments. Many investors inadvertently inflate their rates of return by using methodologies that do not isolate growth factors. The most notorious example is that of ‘The Beardstown Ladies’, a small-town investment club that regularly beat the performance of Wall Street professionals. It was later revealed that the club used a methodology that did not isolate sources of growth. As a result, its rate of return included monthly contributions that members made to the club. When these contributions were factored out, the club's performance fell short of the market by a significant margin.

Once a rate of return has been calculated, it is compared to the return of a market index used to benchmark the asset class involved. In accordance with the best mode currently contemplated for the invention, the present invention employs the indices such as those listed in Table II, below, to benchmark supported asset classes. Certain esoteric asset classes, such as micro-cap stocks and emerging market stocks, are omitted at present, because they are considered by many to be speculative, rather than investment-grade, securities. Similarly, certain asset sub-classes, such as growth and value segments of large-cap U.S. stocks are omitted at present, because the inventors have found that over the long term, these sub-class distinctions are far less important than the overall allocation among core asset classes. It will be understood, however, that the omitted asset classes may be included in the operation of the inventive method.

TABLE II

| Asset Class | Index |
|---|---|
| Cash/Money Funds | 31-Day US Treasury Bills |
| Bonds | Shearson-Lehman Intermediate- |
| | Term Bond Index |
| Large-Cap U.S. Stocks | Standard & Poor's 500 Index |
| Mid-Cap U.S. Stocks | Russell 2000 Index |
| Large-Cap Int'l. Stocks | Morgan-Stanley EAFE Index |

The benchmark returns for asset classes are given the same relative weights as in the investment mix's or investment portfolio's target asset allocation, and combined into a composite benchmark for the portfolio. Similarly, the standard deviation of each benchmark is melded into a composite risk index for the mix or portfolio. Both the composite return and the composite standard deviation are calculated using industry-standard methods. The composite standard deviation calculation accounts for the impact of cross-correlations among asset classes in the mix or portfolio. For an explanation of the methods used, see, e.g., Brown & Kritzman, pp. 168-174, which is hereby incorporated by reference. As a result, each portfolio is measured against a custom, composite benchmark, whose components are weighted to reflect the mixes’ or the portfolio's target asset allocation. The rate of return calculated for the mix or portfolio will reflect its actual asset allocation over the period being measured.

A fund should be highly correlated to the index that is chosen to measure its performance; in other words, the fund and the index should generally move in the same direction at the same time. It would not be fair to use the S&P 500 to measure the performance of a mid-cap fund, since mid-caps are inherently more volatile than the S&P 500. Instead, one would select an index, such as the Russell 2000 index, that more closely mirrors the performance of the overall mid-cap market.

For the same reason, a single index cannot be used to measure the performance of an entire mix or portfolio. Instead, a weighted composite index is preferably used. To build a weighted composite index, one first selects an appropriate index for each fund in the investment mix or portfolio. Then each index is assigned a weight equal to the target weight of the fund in the portfolio. For example, if a fund is assigned a target weight of 33% in the mix or portfolio, its index will be given a 33% weight in the composite index. The return of each fund index is multiplied by its weight, and the results are summed to produce a composite return index for the overall mix or portfolio. The method employed by the present invention to calculate a composite index is described in Brown and Kritzman at pp. 167-168, which is hereby expressly incorporated by reference.

A composite risk index can be created using a similar procedure. However, cross-correlations between asset classes must be taken into account when calculating a composite risk index. The present invention employs a composite risk index creation procedure such as that described in Brown and Kritzman at pp. 168-174, which is hereby expressly incorporated by reference.

The present invention employs an algorithm well known as “Markowitz-Todd Mean Variance Optimization” (the ‘MT Algorithm’) to calculate the mixes presented to the user. The algorithm implements a form of “mean-variance optimization” (“MVO”). The MT Algorithm is described in Markowitz, H. M., Todd, G. P., Mean Variance Analysis in Portfolio Choice and Capital Markets (Frank J. Fabozzi Associates, Rev. Ed. 2000) (hereinafter “Markowitz & Todd”), which is hereby incorporated for purposes of both the MT Algorithm and MVO.

MVO is a model of the expected behavior of different fuidamental types of investments, known as asset classes, when combined in different ways. The model consists of a set of investment mixes, each of which is efficient, in the sense that the mix provides the maximum return that is feasible at a given level of risk, given the asset classes included in the model and the constraints to which the model is subject.

A user selects asset classes to include in an optimization by choosing from a list of asset classes supported by the present invention. The user can specify a minimum weight for any asset class in all mixes generated by the optimization. For example, the user can specify that all mixes must contain at least 10% cash. Similarly, the user can specify a maximum weight for any asset class. For example, the user might specify that no mix or portfolio may contain more than 30% large-cap U.S. stocks.

The user can specify minimums and maximums for asset classes in any combination desired. For example, by setting both a 10% minimum and a 10% maximum on cash, the user can specify that all mixes or portfolios must contain exactly 10% cash.

A MVO is designed to generate a set of ‘efficient’ investment mixes. An efficient mix is one that can be expected to generate the highest attainable return at the mix's given level of risk. In other words, once a user knows how much risk he can live with, an MT optimization identifies the mix of investments that will provide the highest return at that level of risk. Thus, the benefits of MVO are twofold: 1) It identifies the investment mix most likely to provide the highest return at the given level of risk; and 2) It provides the user with a level of control over investment risk, by providing a mix with a known and verifiable level of risk.

To illustrate the point, assuming two investment mixes, Mix A and Mix B, as shown in FIG. 1. Let us further assume that both mixes have the same standard deviation, a statistic that is commonly used to measure risk. If Mix A has a higher expected return than Mix B, we say that Mix A is more efficient than Mix B, since it delivers a higher expected return at the same level of risk. Markowitz observed fifty years ago that all other things being equal, a reasonable investor would prefer Mix A over Mix B.

The same analysis can be applied on the assumption that return, not risk, is the given, as shown in FIG. 2. Let's assume that Mixes A and B have the same expected return, and that Mix A has a lower standard deviation than Mix B. We would once again conclude that Mix A is more efficient than Mix B, this time because is produces the same level of return at a lower level of risk.

The mixes calculated by an MT optimization fall along an arc that is commonly called the “efficient frontier.” The mixes that fall along the efficient frontier can be expected to generate the highest attainable return at each point along the risk spectrum (represented by the x-axis in the above diagrams). In short, an MT optimization generates an efficient frontier such as the ones shown in the above diagrams. It also provides a basis for calculating any arbitrary number of mixes that fall along the efficient frontier.

Minimum and maximum limitations are known as “constraints” upon an optimization. As the number of constraints increases, it becomes more likely that various constraints will conflict with other constraints. Consider the extremely simple example of a minimum of 30% large-cap U.S. stocks, and a maximum of 25% of the same asset class. It is not possible to create a mix that would satisfy both of these constraints; therefore, the problem is said to be infeasible. Obviously, it is not very likely that a user would input the sort of conflicting constraints shown in the example. However, infeasability presents a possible problem for any optimization. For this reason, the MT Algorithm tests for infeasibility early in the optimization process.

Additionally, there is a budget constraint implicit in MVO. A budget constraint requires that that all weights in the mix or portfolio add up to 100%. Some MVO models allow for short selling, in which case an investment would have a negative weight in a portfolio, and portfolio weights would not add up to 100%. In order to simplify the present invention, in accordance with the preferred embodiment of the invention, a budget constraint is included to any MVO calculated such that the user's ability to include short sales does not alter the cumulative portfolio weights. It will be understood, however, that ability to include short selling may be included in the method of the present invention by factoring the short sale into the budget constraint and MVO calculation.

In accordance with the preferred embodiment of the present invention, an MVO proceeds generally as follows: First, the software acquires and validates the data needed to perform the optimization. Next, the software performs a simplex optimization on the data. This optimization produces a single mix, which can be expected to generate the highest return attainable, given the asset classes included in the mix and the constraints to which it is subject. Then, the software performs a critical line optimization on the data, using the results of the simplex optimization as a seed. This optimization produces a set of corner portfolios, each of which can be expected to generate the highest return attainable at the portfolio's given level of risk. These corner portfolios constitute an ‘efficient set’ that ranges from very conservative to very aggressive.

The MT Algorithm will generate a dozen or so corner portfolios. In accordance with the contemplated preferred embodiments of the invention, a user is offered a selection of 100 efficient portfolio mixes. It will be understood that the presentation of 100 portfolio mixes is somewhat arbitrary and, other quantities of portfolio mixes are equally contemplated by the present invention. For example, as few as twenty-five or as great as five hundred investment mixes may be generated and presented to the user. To generate these mixes, the present invention interpolates additional mixes between the corner mixes generated by the MT Algorithm. As noted in Harry M. Markowitz, Portfolio Selection, (Blackwell, Reprinted 1997 pp. 23-24) (hereinafter “Markowitz-Blackwell”), mixes that are interpolated between corner mixes are just as efficient as the corners themselves. According to Markowitz-Blackwell, any weighted average of consecutive corner portfolios are also efficient portfolios (Markowitz-Blackwell, p. 24). Additionally, Markowitz-Blackwell presented a theorem for variance of a weighted sum of two variables which is utilized in the present invention to interpolate two consecutive corner portfolios or mixes by variance. See, Markowitz-Blackwell, pp. 88-89.

Markowitz & Todd presents a more complete discussion of the MT Algorithm and MVO. Chapter 13 of Markowitz & Todd provides an implementation of the MT Algorithm in Microsoft Visual Basic for Applications at pages 301-338, as an example for applications development.

The present invention departs from the MT Algorithm in the following respects: For each asset class, the MT Algorithm expects the following inputs, which are commonly referred to as the ‘assumptions’ used by the optimizer: (1) The expected return of the asset class; (2) the variance of the asset class; and (3) the covariance of each asset class with each other asset class included in the optimization. The optimization engine employed in the present invention expects the following inputs: (1) The expected return of an asset class; (2) the standard deviation of the asset class; and (3) its correlation to each other asset class in the model.

The inventive optimization engine uses standard deviations, rather than variances, because standard deviations are more widely used as a measure of risk. These standard deviations are calculated in the manner described by in Ibbotson Associates, 2005 SBBI Yearbook (2005) (hereinafter “Ibbotson”) at page 206, which is hereby incorporated by reference. These standard deviations are converted to variances for use in the MT Algorithm, by applying the standard formula v=(sd)², where v equals variance and sd equals standard deviation.

Similarly, the inventive optimization engine uses cross-correlation coefficients, rather than covariances, because cross-correlations are more widely used than variances to express the degree that one investment's return is influenced by the return of another investment. The cross-correlations are calculated in the manner described by Formula 26 in Ibbotson at p. 114. These correlations are converted to covariances for use in the MT Algorithm, using Formula 27 in Ibbotson at p. 114.

A user is not required, and preferably, cannot, enter these assumptions. Instead, the assumptions are preferably calculated by the supplier on a quarterly basis and provided to users of the software. They are stored as applications setting on the user's computer and read into memory as needed by the present invention.

The present invention employs a “building blocks” approach in calculating its assumptions. The methodology is similar to that described in the Ibbotson at p. 114 et seq. The present invention operates on a user's computer and may be updated periodically via electronic connection to a remote server which maintains updated optimization assumptions and software updates to the present invention. If updated assumptions or software is available, the software downloads them from the servers and saves them on the user's computer.

These and other objects, features and advantages of the present invention will become more apparent to those of ordinary skill in the art from the following detailed description of the preferred embodiments of the present invention taken with reference to the accompanying figures.

### BRIEF DESCRIPTION OF THE FIGURES

FIG. 1 is a graph depicting a risk return curve illustrating two portfolios having the same risk, but differential returns.

FIG. 2 is a graph depicting a risk return curve illustrating two portfolios having the same return, but differential risks.

FIG. 3 is a flow diagram illustrating investment mix selection in accordance with the method of the present invention.

FIG. 4 is a flow diagram illustrating risk-return selection in accordance with the method of the present invention.

FIG. 5 is a flow diagram illustrating investment mix calculation in accordance with the method of the present invention.

FIG. 6 is a flow diagram illustrating performance evaluation calculation in accordance with the method of the present invention.

FIG. 7 is a flow diagram illustrating user entry of transaction data in accordance with the method of the present invention.

FIG. 8 is a flow diagram illustrating transaction reporting in accordance with the method of the present invention.

FIG. 9 is a screen-shot illustrating a investment mix selection set up screen in accordance with the method of the present invention.

FIG. 10 is a screen-shot illustrating a risk-return view of the investment mix selection screen in accordance with the method of the present invention.

FIG. 11 is a screen-shot illustrating a historical returns screen for a selected investment mix in accordance with the method of the present invention.

FIG. 12 is a screen-shot illustrating an efficient frontier display for a selected investment mix in accordance with the present invention.

FIG. 13 is a screen-shot depicting a transactions screen for a purchase transaction entry in accordance with the method of the present invention.

FIG. 14 is a screen-shot depicting a transactions screen for a sale transaction entry in accordance with the method of the present invention.

FIG. 15 is a screen-shot depicting a transactions screen for an income distribution entry in accordance with the method of the present invention.

FIG. 16 is a screen-shot illustrating a transaction screen for a capital gains distribution entry in accordance with the method of the present invention.

FIG. 17 is a screen-shot depicting a transaction screen for entering a transaction adjustment in accordance with the method of the present invention.

FIG. 18 is a screen-shot illustrating a transaction screen for re-valuing an investment portfolio in accordance with the method of the present invention.

FIG. 19 is a screen-shot depicting a transactions screen for re-balancing an investment portfolio in accordance with the method of the present invention.

FIG. 20 is a screen-shot illustrating a reports screen and reports view sub-panel display in accordance with the present invention.

### DETAILED DESCRIPTION OF THE PREFERRED EMBODIMENTS

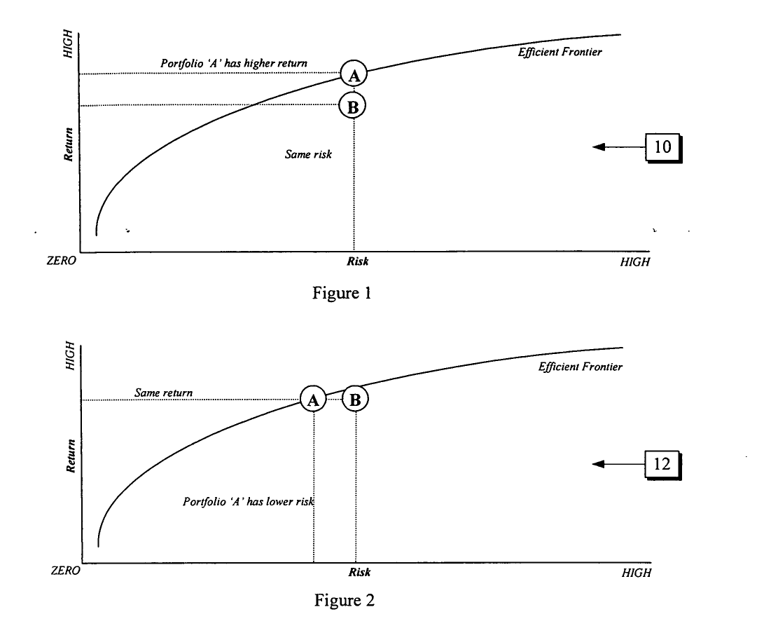

FIGS. 1 and 2 are described in greater details above, and represent different returns for two hypothetical portfolios, each having the same risk level (FIG. 1) and different risks for two hypothetical portfolios, each having different rates of return (FIG. 2), both figures representing a graph of the efficient frontier.

Fundamentally, the method of the present invention entails the following general steps. First, a user creates a portfolio file to use with the inventive software program. The file is created in the normal Microsoft Windows manner.

Once a file has been created, the user creates an investment mix and works with it as follows: Step 1: The user decides which asset classes to include in the investment mix, sets any upper or lower limits desired for any or all of those asset classes, and chooses investment funds to represent those asset classes in the investment mix. When the user is finished, the inventive system calculates 100 different investment mixes that range from very conservative to very aggressive. Step 2: The user scrolls among the investment mixes that the present invention has created, looking for the mix with the combination of risk and return that the user finds most preferable. The user is encouraged to pay particular attention to the potential loss over a one-year period, and the likely time required to recover from such a loss. For example, a user may feel that a mix that could (a) suffer a 7% loss over a one-year period, and (b) take three years to recover from that loss, is simply too risky. That user would scroll to a less aggressive mix. When the user has found the portfolio that he feels offers the best combination of risk and return, he selects it, and the selection is recorded. Step 3: The user enters transactions (deposits, withdrawals, income received, and the like) into the present invention. Step 4: The user periodically creates reports that display the performance of the portfolio, as well as other portfolio reports. In addition, the present invention monitors the portfolio and periodically suggests rebalancing. To rebalance the portfolio, the user prints out a rebalancing report and communicates the rebalancing transfers to the investment company whose funds are used in the portfolio.

The present invention has three main components: (1) calculation of investment mixes and selection of a portfolio from among those mixes; (2) the recording of transactions; and (3) performance evaluation. The three functions of the software are used substantially in that order. When the user first opens the software system of the present invention, the ‘work area’ of the program is empty. At this point the user has two options. He can either create a new file or open an existing file. A new file is created by the user selecting “New” from the standard Microsoft Windows File sub-menu. A new file is then created and may consist of a single investment portfolio or mix comprised of mutual funds or other common ftmds, such as variable annuity funds, hereinafter simply referred to collectively as “funds.” After the new file is created, it may be saved in conjunction with the portfolio or mix by being prompted by a standard Windows File-Save dialog box and entering the appropriate directory path and file name for saving the file on the user's storage media associated with the user's computer.

The ‘client area’ of inventive system (the portion of the window below the main menu and to the right of the icon bar on the left) is occupied by one of several “work panels” or sub-panels, depending on the task to be performed. When the new file is created, a Home Panel is opened in the work area. The Home Panel preferably contains a calendar, a list of notifications from the program, and a “to do” list entered by the user. When a new file is first opened, the calendar is set to the current date, and the Notifications and To Do lists are empty.

Once the user has created a file, the first task is to create an investment mix for that file. An investment mix may consist of a money market fund, a bond fund, a large-cap US stock fund, a smaller-cap US stock fund, and a large-cap international stock fund. Those of ordinary skill in the art will understand that a large variety of different funds may be included in an investment mix, including, without limitation, mutual funds, stocks, bonds, options, commodities, etc. In accordance with the preferred embodiments of the invention, however, reference will be made to mutual funds, without intending to exclude alternate investment types.

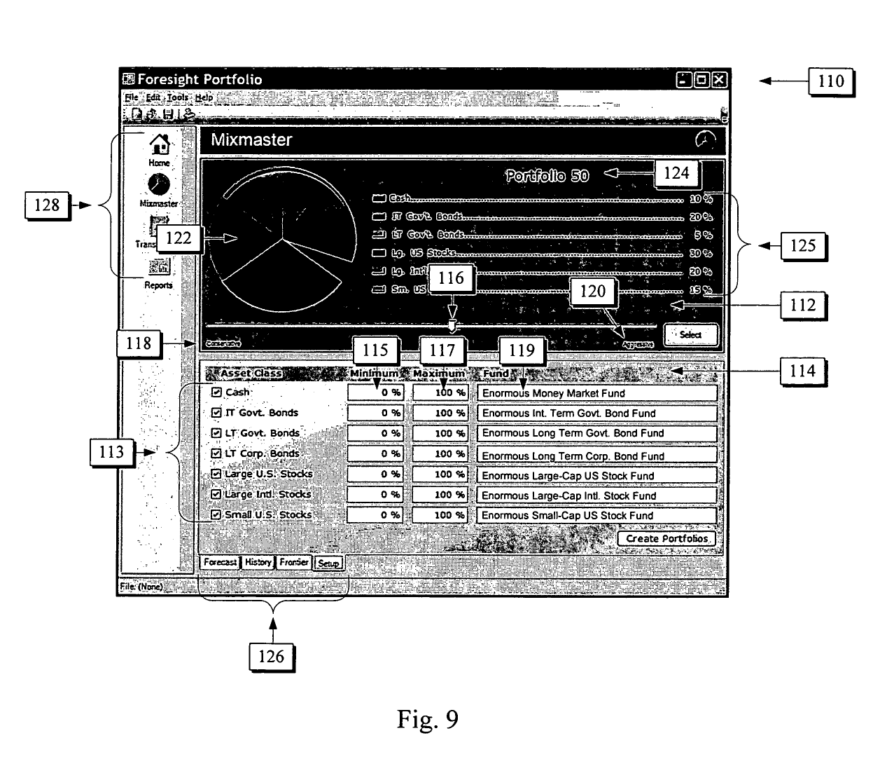

To create a mix, the user selects the “Select” icon from the program's navigation bar, and the Home Panel is unloaded and the Select screen is loaded and displayed. The basic display paradigm for many of the screen displays, as illustrated in FIGS. 9-13, includes a first sub-display panel 112 and a second sub-display panel, e.g., 114, as are discussed in greater detail below. A tabbed panel 126 is provided to permit the user to navigate between different screen displays and program entry and display function. A different screen display is brought to the front by selecting its corresponding tab in the tabbed panel 126.

A control commonly referred to as a slider control or slider bar 116 is provided, and has a plurality of positions, preferably 100, but may be as few as 10 and as many as 500, each of which corresponds to a different mix of asset classes, ranging from extremely conservative to extremely aggressive. A user selects the slider control 116 and drags it toward either the conservative or the aggressive ends, 118, 120, respectively, and examines the investment mix of asset classes in either the first sub-display panel 112 or in the second sub-display panel 114. When the user has found the asset class mix that he wants to use for his investment mix, he clicks a “select” icon button adjacent the slider control 116.

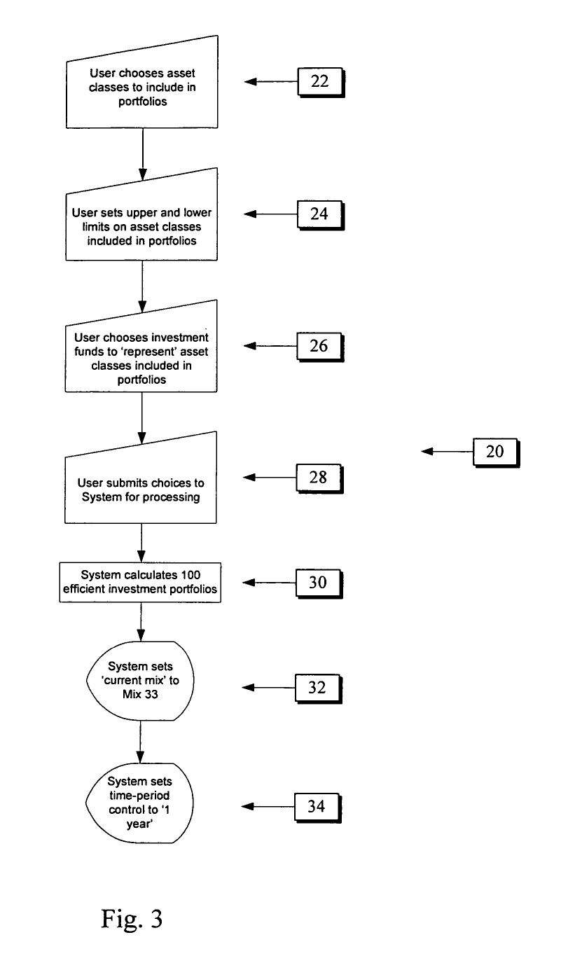

FIGS. 3-8 are high level process flow diagrams representing functionality of the method of the present invention. FIG. 3 depicts an investment mix set up procedure 20 in accordance with the present invention. The investment mix set up procedure 20 consists generally of the following steps: first at step 22, a user selects asset classes to include in the investment mixes, second at step 24, the user sets upper and lower limits on the weight percent of each selected asset class to be included in the mixes; third, at step 26, the user selects investment funds representative of the asset classes included in the mixes; fourth, at step 28, the user submits the asset class and investment choices to the inventive system for processing. At this point, the inventive method then calculates, at step 30, a pre-determined number, e.g., 100, of efficient investment mixes based upon the user's input asset classes, weighting and investment funds, then at step 32, the system sets a current investment mix flag to a designated default index value, e.g., “Mix 33”, and sets a default time period control for the current investment mix at one year, as step 34. The time period control may be overridden by the user as desired to expand or narrow the time period, e.g., between one week to five to twenty years.

In setting up the investment mix, the user is presented a screen, such as that in FIG. 9, which represents a prototypical screen display 110 for investment mix selection. Screen display 110 consists generally of at least two main sub-display panels 112 and 114, sub-display panel 112 includes a graphical representation 122 of an investment mix 124 and a legend 125 having a listing of asset classes and weight percentages for each asset class contained in the graphical representation 122. In accordance with the preferred embodiment of the invention, it is contemplated that the graphical representation 122 consists of a pie chart having sections corresponding in area to the relative percentage of individual asset classes in the investment mix 122.

Sub-display panel 114 provides a generally tabular display of asset classes 113, minimum weight percent 115 for each asset class, maximum weight percent 117 for each asset class and a description 119 of a selected fund for each asset class. A slider bar 116 is provided which permits the user to select an investment mix having risk levels between conservative risk 118 at one end of the slider bar 116 and an aggressive mix 120 at an opposite end of the slider bar 116. When the slider bar 116 is moved in either the direction of conservative risk 118 or aggressive risk 120, the display in each of sub-display panels 112 and 114 is dynamically updated based upon the investment mix selected by the user using the slider bar 116 to display investment mixes having either a relatively more conservative or relatively more aggressive mix of weighted percentages of investments in the investment mix.

Asset classes rather than fund names are displayed because it has been found that asset class selection is determinative of approximately 90% of investment performance over time.

Each asset class has an adjacent check box, and adjacent text entry boxes for entry of a minimum weight percent 115, a maximum weight percent 117 and a fund descriptor 119. A particular asset class is selected by the user checking the check box, to include the asset class in the investment mix, then specifying the minimum and maximum weights to be accorded to the selected asset class in the investment mix. If the check box is left unselected, the asset class is not included in the investment mix, is displayed in grayed out font, and the text entry boxes for entering weights are disabled.

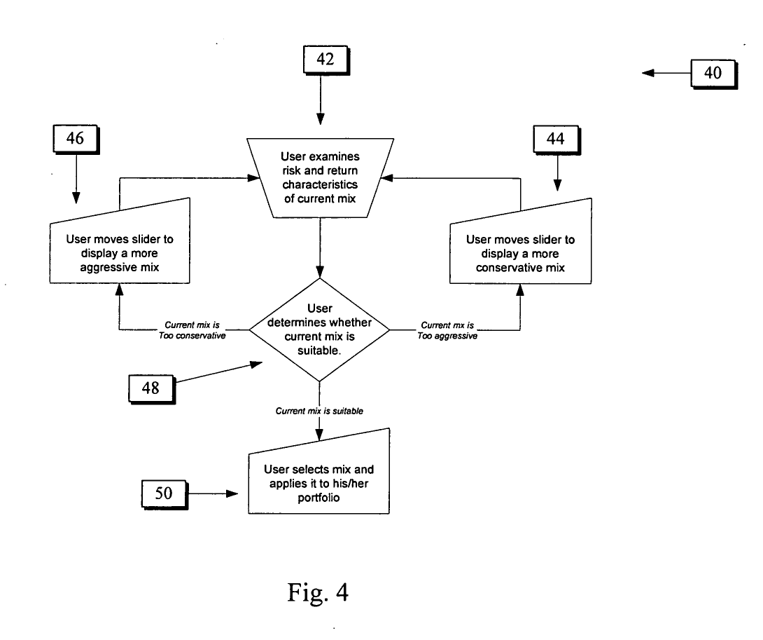

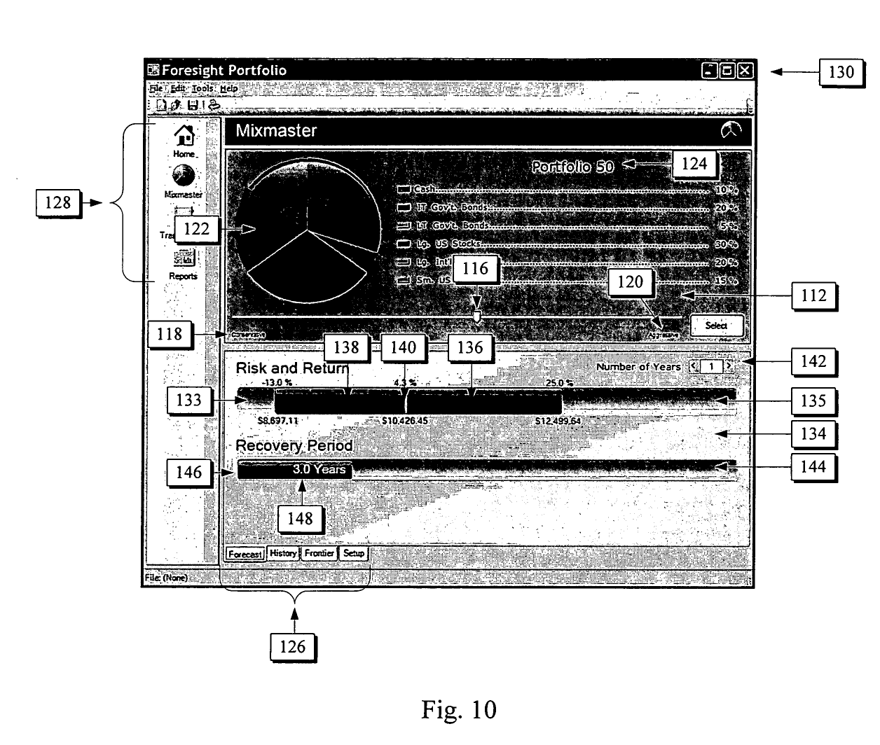

FIG. 4 graphically depicts the process flow employing the screen display 130 of FIG. 10. Screen display 130 in FIG. 10 is identical to screen display 110 of FIG. 9, except that sub-display panel 132 is substituted for sub-display panel 114 of FIG. 9. Sub-display panel 132 displays preferably has three elements: first, bar-type graphical display 134 of the relative risk and return for the investment mix selected and displayed in sub-display panel 112, second a bar-type graphical display of the recovery time for a maximum loss on the investment mix (the “recovery display”) 144, and third, a time period selector 142, which permits the user to select a time period between, preferably between one week and twenty years, for which the risk return display 134 and the recovery display 144 are dynamically updated based upon the investment mix selected. The risk and return bar display 134 includes a section representing return 136 and a second representing risk 138. Percentages for average risk and return for the selected investment mix over the selected period based upon historical data are displayed as numerals adjacent the risk and return bar display 134. Similarly, investment mix valuation based upon a hypothetical $10,000 initial investment are displayed as adjusted dollar values representing the return on the initial investment or the loss on the initial investment over the selected period based upon historical averages. A mean bar 140 is displayed on the risk and return bar display 134 to graphically represent the arithmetic mean gain or loss of the selected investment mix over the selected time period in both percentage and dollar values based upon the hypothetical $10,000 initial investment.

The risk and return display 134 preferably includes a plurality of segments: a first segment 138, preferably colored red or other suitable color, represents a range of expected performance that falls below a zero percent return, or an expected loss; a second segment 136, preferably colored green or other suitable color, represents a range of expected performance that falls above a zero percent return, or an expected gain; a third segment 135, preferably colored gray or other suitable color forms the display background and extends from the second segment 136, i.e., the gain segment, and represents the highest return, or gain potential, that may be expected from the selected investment mix; finally, a fourth segment 133, preferably colored gray or other suitable color, also forms the display background and extends from the first segment 138, i.e., the loss segment, and represents the greatest loss, or loss potential, that may be expected from the selected investment mix. All returns are calculated by applying standard statistical procedures to expected return and standard deviation assumptions, using a 95% degree of confidence. For example, the portfolio illustrated by FIG. 10 has an expected return over any one-year period of 4.3%. Thus, $10,000 deposited in this portfolio at the beginning of the year may be expected to grow to $10,426.45 by the end of the year. Over a long period of time, the cumulative performance of the portfolio can be expected to average a rate close to 4.3% However, in any given year, the performance of the selected investment mix can vary widely from this rate. In the worst case, the portfolio can lose 13.0%. In the best case, the portfolio would exhibit a 25.0% gain.

The recovery display 144 displays an estimated time 148 expected for the investment mix to recover to a break-even position after a loss. The time estimate figure is expressed in decimal years, and is calculated by applying standard statistical methods to the same risk and return assumptions used in the risk and return display 134. The calculation includes these formulas: Ibbotson; Formula 32, p. 164 and Ibbotson; Formula 35, p. 165, which are hereby incorporated by reference. The recovery figure is preferably calculated to a 95% level of confidence. The recovery period is preferably graphically presented as a single horizontal bar having two segments: a first segment 148, which may be colored red or other suitable color, represents the expected break-even period for the investment mix, as the break even period increases, the first segment becomes enlarged to reflect a longer duration of the recovery or break even period; a second segment, which may be colored gray or other suitable color, preferably represents the recovery period or break even period for the most aggressive mix in the selected investment mix set. For example, for the mix indicated in FIG. 10, the user may expect to take an average of 3.0 years to recover from a loss. Thus, if as indicated on the risk-return bar 134, the user experienced a maximum loss equal to 13% of a hypothetical $10,000 initial investment, it would take the user an average of 3.0 years at average rates of return for the selected investment mix to recover from the loss to a break even of the initial $10,000 invested.

In the process of the present invention described in FIG. 4, a first investment mix is displayed and the user examines the risk and return of the displayed investment mix at step 42. The user then determines whether the first investment mix is suitable for their purposes at step 48. If the first investment mix is too aggressive, the user then moves the slider on the slider bar 116 toward the conservative end 118 of the slider bar 116 and re-examines the risk and return in the sub-display panel 132 of another more conservative investment mix. Similarly, if the first investment mix is too conservative, the user may move the slider on the slider bar 116 toward the aggressive end 120 of the slider bar 116, and re-examines the risk and return in the sub-display panel 132 of another more aggressive investment mix. Once the user identifies an acceptable investment mix, the user selects this investment mix and applies it to the portfolio at step 50.

The next step in setting up a portfolio is to select funds to represent each asset class. A sophisticated user will probably know which funds he wants to use. A user may simply enter the names of the desired funds into the fund descriptor text box 119 associated with each selected asset class. An unsophisticated user will likely not know which funds he wants to use, and may select funds from a look-up list labeled “Fund Companies” which lists the largest and best-known mutual fund families in the United States. Summary information on each of the mutual fund families and companies may be provided, and may include, for example a ranking of those companies based on: (a) Their expense ratios, with the least expensive funds ranking highest; and (b) their faithfulness to the asset class they represent based upon, i.e., the fund that best represents an asset class is the one with the highest correlation coefficient (r²) to the market index used to measure the performance of the asset class.

After the user has selected both the asset classes and funds, portfolios are calculated by selecting a “calculate portfolios” button on the “setup” page. Different investment mixes are then calculated using the MT Algorithm and MVO method stored in the computer's RAM. A plurality of investment mixes are output as a result of the calculation, and may be appropriately flagged, for example, as “Mix 1” to “Mix 100” with Mix 1 being the most conservative mix and Mix 100 being the most aggressive mix computer by the MVO method.

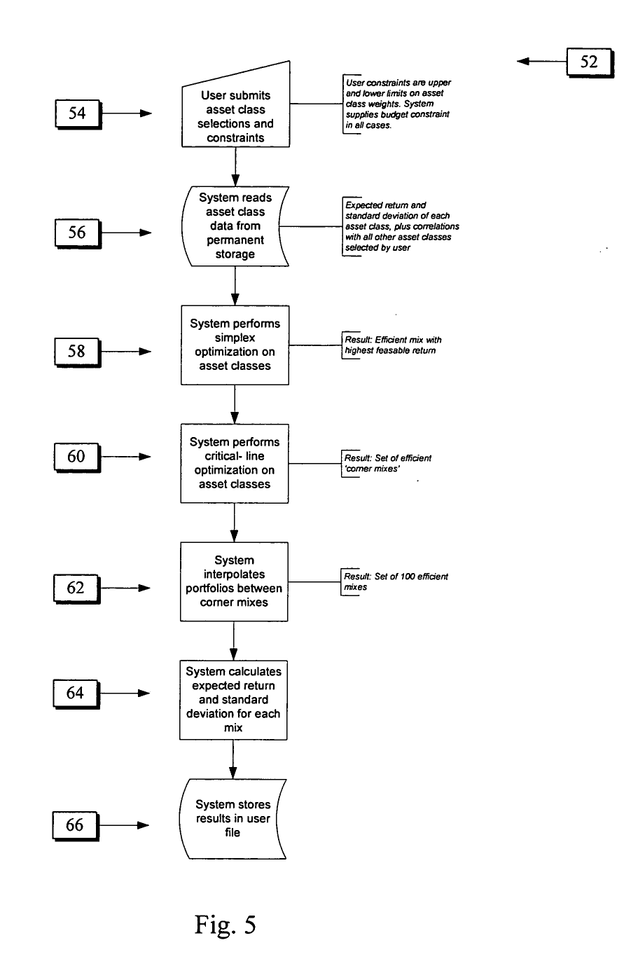

The process flow of investment mix calculation 52 is illustrated in FIG. 5 and begins with the user selecting the asset classes and minimum and maximum weight percentages accorded to each asset class 54 as described above. The selected asset classes are read from storage media at step 56, which may be either resident on the local computer or may be accessed electronically via a remote connection, such as the Internet. The computer system then performs simplex optimization using the MT Algorithm and MVO on the selected asset classes at step 58 to generate the most efficient mix with the highest expected return. Then the system performs a critical-line optimization on the selected asset classes at step 60 to yield a set of efficient corner mixes. Then, a set of efficient mixes is produced at step 62 by interpolating the set of efficient corner mixes from step 60. The computer system then calculates expected rates of return and standard deviation for each mix in the set of efficient mixes at step 62, and stores the results in a user file at step 66. Both the simplex and critical line optimizations are employed as part of the same MVO process, and lead to a single solution set.

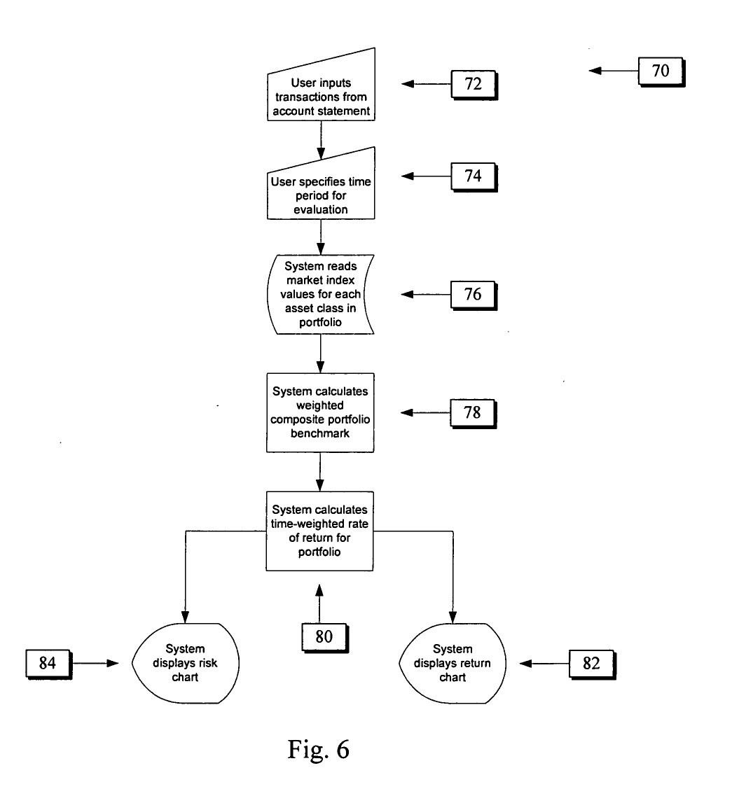

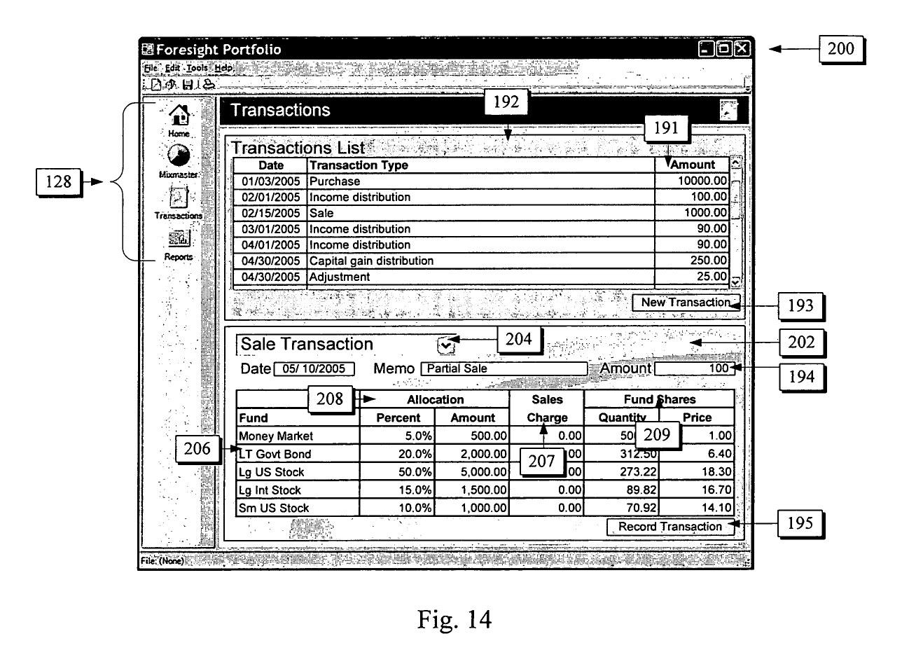

In presenting the risk-return information, the present invention employs a default time period of one-year, even if the user's time horizon, i.e., the period of time until the user reaches his financial goal; e.g., his retirement date. is much longer. Most investment programs that offer pre-built portfolios base their recommendations on the user's time horizon. However, it has been determined that one year planning is optimum for most non-institutional investors. Turning now to FIG. 6, there is shown the routine for evaluation of the user's performance 70. User transactions are input 72 from account statements from the funds, or from electronically downloaded statement information provided by the funds in which the user is invested. Transactions may be entered in a manner as described with reference to FIGS. 14-20, which depict prototypical transaction input screens, and will be discussed hereinafter. hereinafter, A time period for the evaluation is selected at step 74, and the system then reads market index values stored on a storage medium located either locally or remotely for each asset class in the selected investment mix at step 76. A weighted composite benchmark is then calculated at step 78, and a time-weighted rate of return for the investment mix or portfolio is calculated at step 80. A time-weighted rate of return is a geometric return. The formula for a time-weighted return is TWR=[(1+R1)(1+R2) . . . (1+Rn)]−1, Where R=the return for a given period, and n is the number of periods. The TWR procedure links the varying returns of successive periods to produce a single rate of return for the span of all of the periods. Then, based upon the results of these calculation, either a risk chart is displayed to the user at step 84 or a return chart is displayed at step 82.

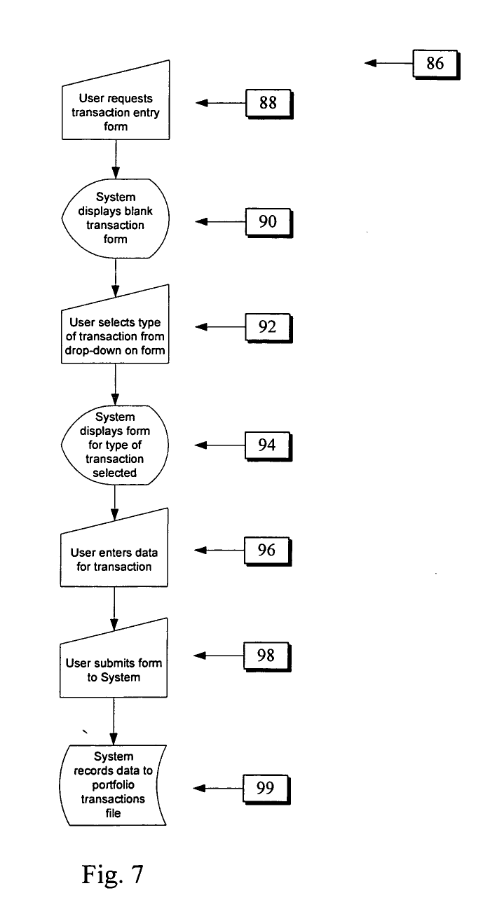

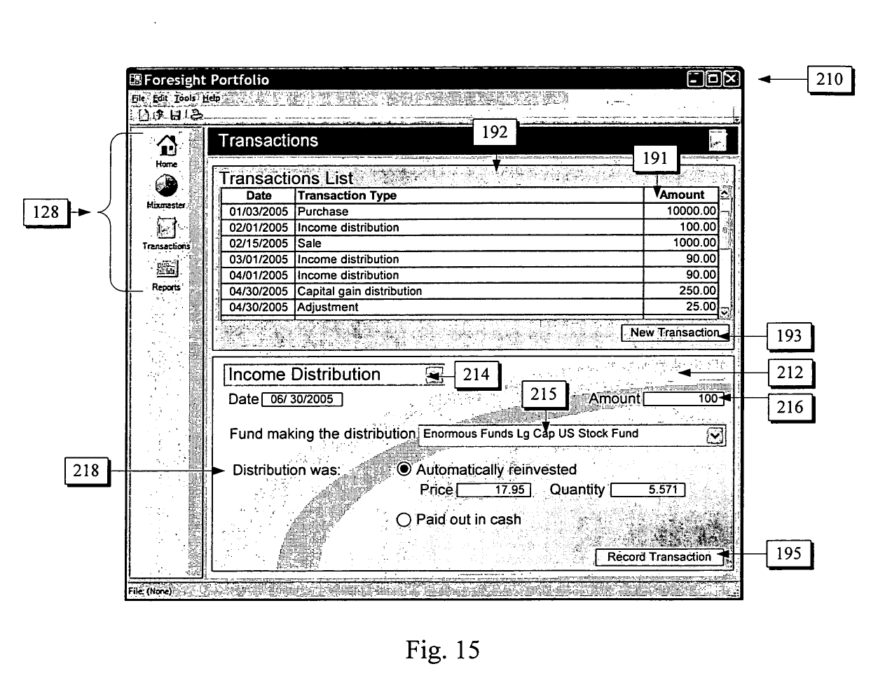

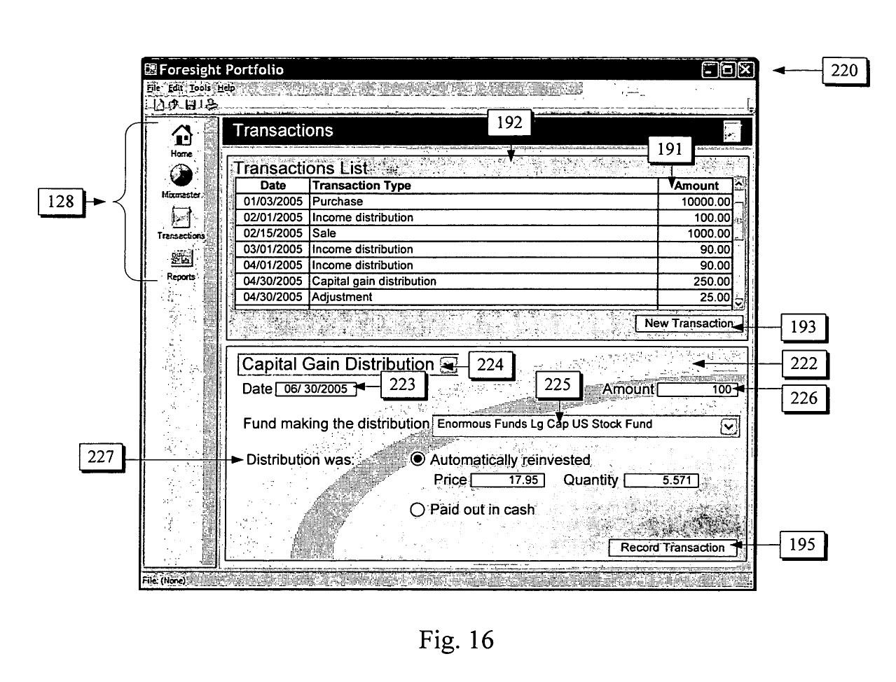

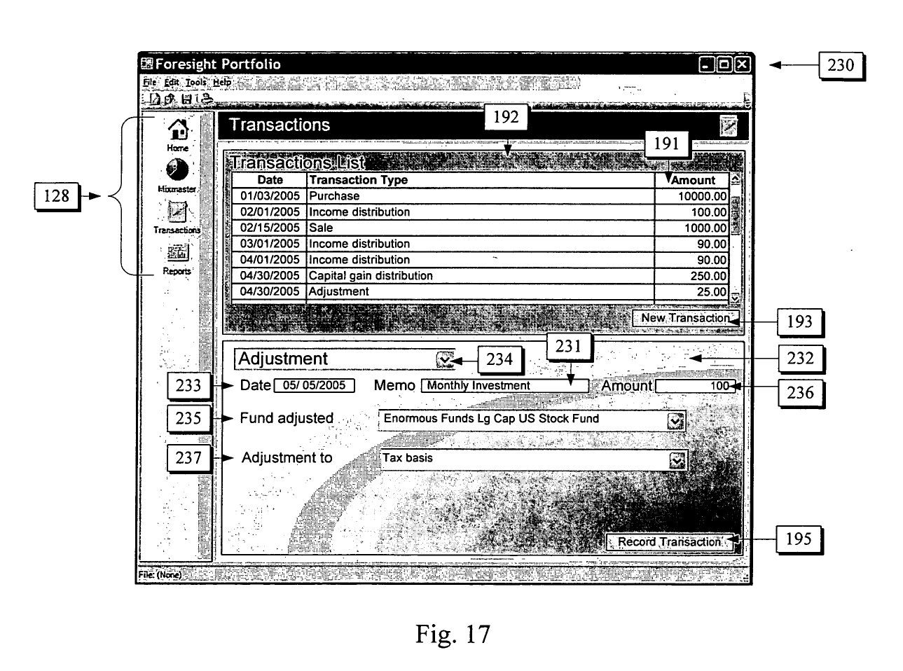

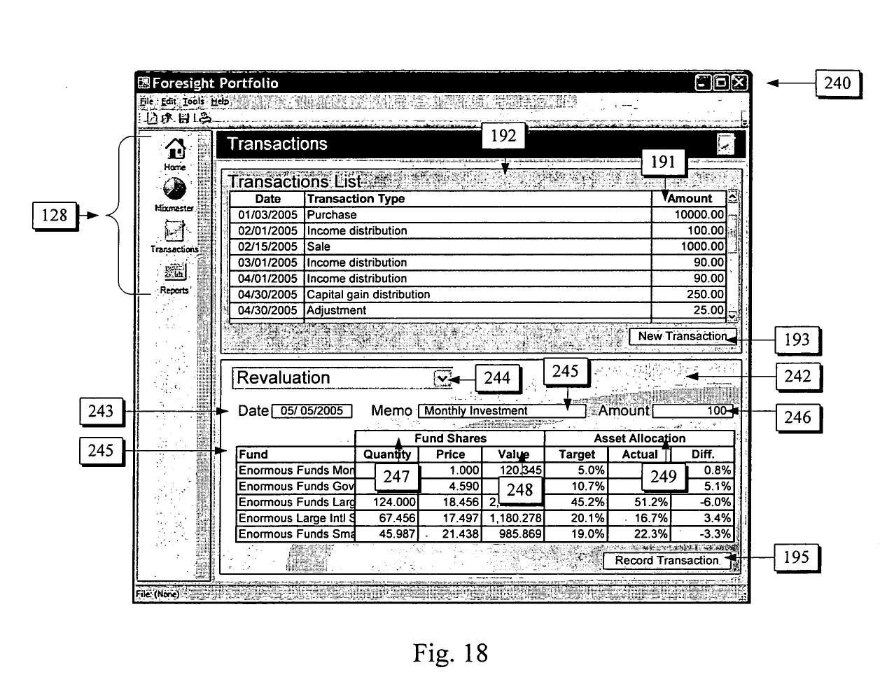

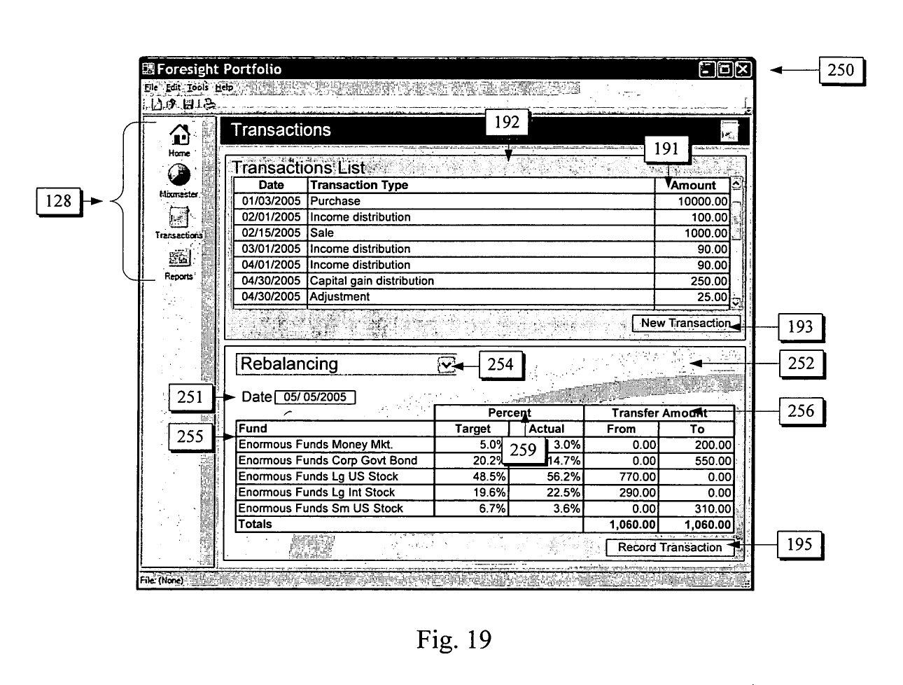

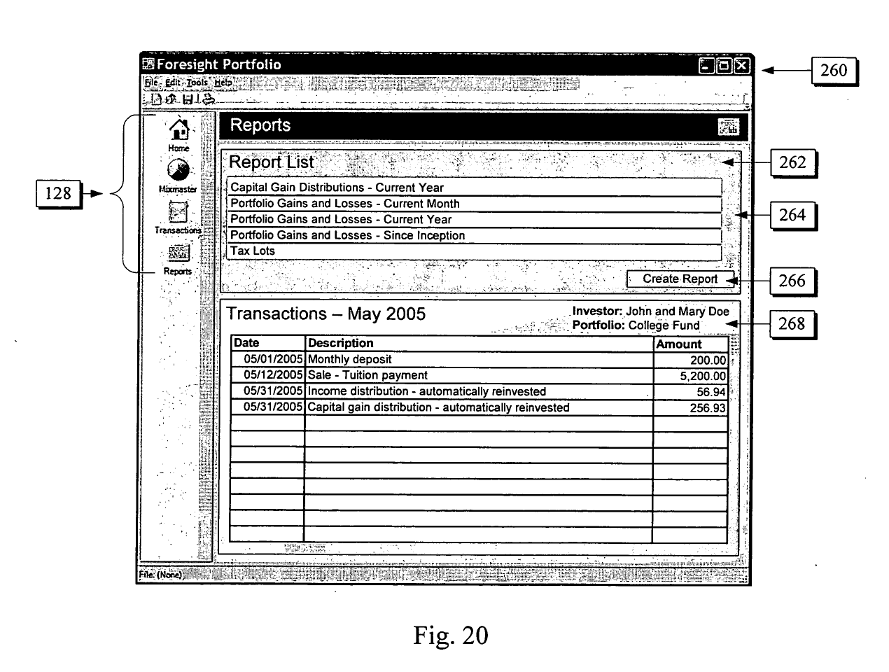

As noted above, user transactions, such as purchase, sale, dividend, capital gain distributions, or the like are entered using entry screens similar to those presented in FIGS. 14-20. In accordance with the method of the present invention, and as illustrated in FIG. 7, user transaction data entry 86 occurs by the user first selecting a transactions entry screen at step 88. A blank transaction entry form is presented to the user at step 90, and the user then selects from a plurality of transaction types, preferably from a drop-down list on the transaction entry form at step 92. The system then displays the appropriate form the transaction type selected at step 94. Thus, as illustrated in FIG. 14, a purchase transaction screen 190 is depicted in which a user selects a purchase transaction 191, from a transaction list 192 and the purchase transaction form 194 is displayed. FIG. 15 displays a similar screen 200 for sales transactions, FIG. 16 displays a similar screen 210 for income distributions, FIG. 17 displays a similar screen 220 for capital gain distributions, FIG. 18 displays a similar screen 230 for entry of adjustments, FIG. 19 displays a similar screen for portfolio revaluation, and FIG. 20 displays a similar screen for a rebalancing transaction. In each transaction type, the user will enter the data for the selected transaction at step 96, and submits the data to the system at step 98, which then records the transactions into a portfolio transactions file at step 99.

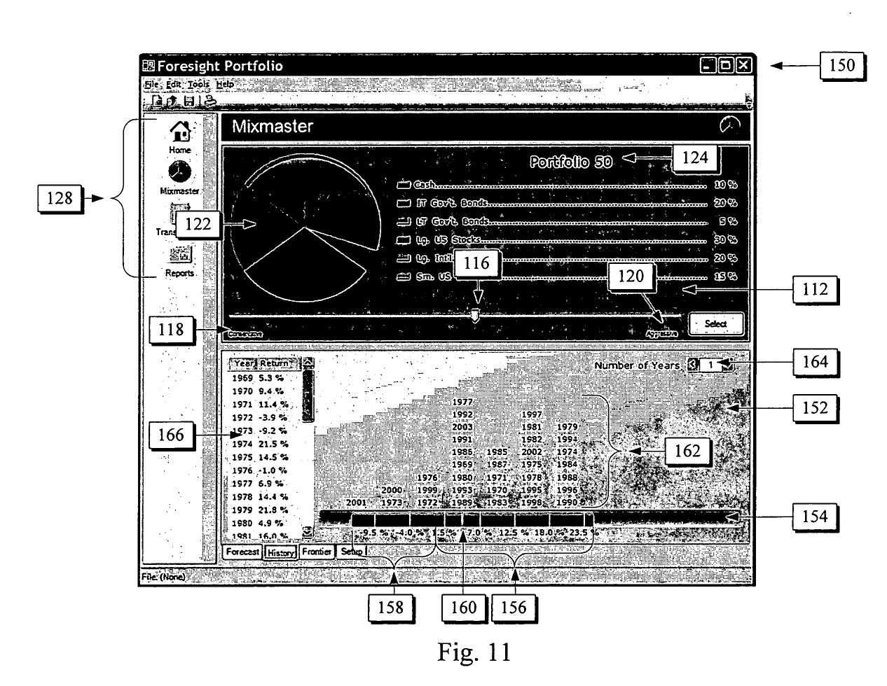

A user may want to review historical returns before making a investment mix or portfolio selection. In accordance with the present invention, a user may access historical returns by selecting a “history” tab from the plurality of window tabs 126 to display a history display screen 150 for the selected investment mix as illustrated in FIG. 11. The history display screen 150 displays in a sub-display panel 152, the annual returns of the selected investment mix or portfolio from a pre-determined historical year, such as, for example 1971, which are then plotted on the risk return display 154 according to year groupings 162 and either risk (loss) 158 or return (gain) percentages 156. Like the regular risk and return display, risk and return display 154 includes a mean bar 160 which statistically represents the mean risk or return percentage over the historical period selected. The historical risk and return display 154 is dynamically updated as the user changes the investment mix selection using the slider bar 116.

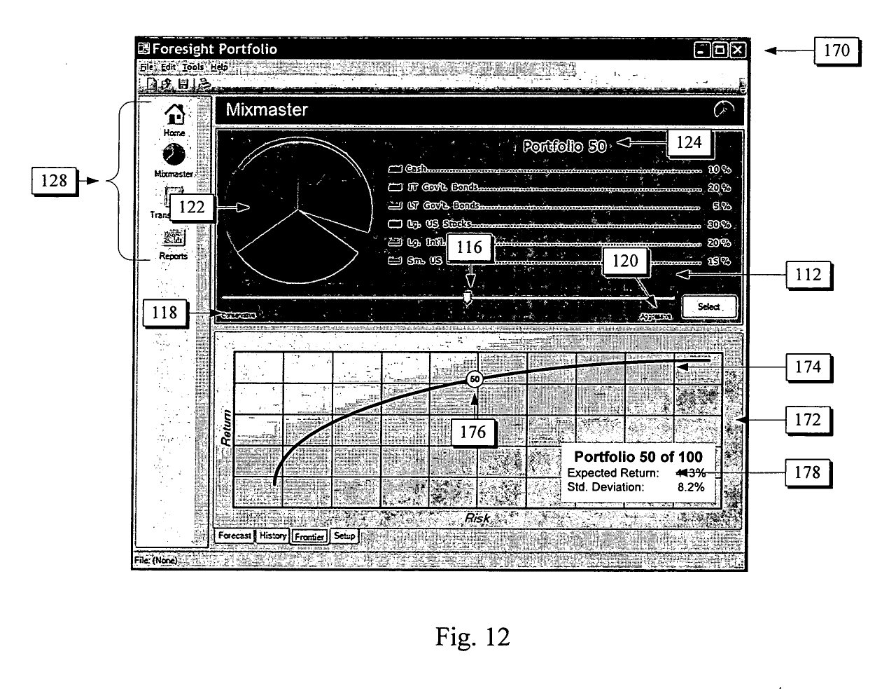

Turning now to FIG. 12, there shown an efficient frontier screen display 170. Screen display 170 is identical in general layout to the screen displays depicted in FIGS. 9-11, except hat a second sub-display panel 172 is provided which graphically displays the efficient frontier curve for the investment mix 124 selected in the first sub-display panel 112. As discussed above, the efficient frontier curve is calculated for plurality of investment mixes, and an efficient frontier point 176 representing the given risk and return for the selected investment mix 124 is displayed on the efficient frontier curve. As discussed in greater detail above, the efficient frontier is generated by employing the MT Algorithm in MVO to generate mixes that are designed to be optimally efficient, in that these mixes are expected to provide the highest return for their given levels of risk. For any one of these mixes, there is no other combination of the selected asset classes that can provide a higher return without taking on additional risk. Risk is measured by variance a standard statistical measure that measures the volatility of a variable, in this case, a mix. There is one such mix for any point along a line stretching from a zero return to the maximum return that can be obtained with the selected asset classes. The efficient frontier point 176 is dynamically displayed for each investment mix 124 selected by the user by activating the slider bar 116. A legend 178 is preferably provided which summarizes the selected investment mix 124 and the risk and return of the selected investment mix 124. Risk and return are preferably expressed as the arithmetic mean expected return and standard deviation (square root of the variance) of the selected investment mix 124.

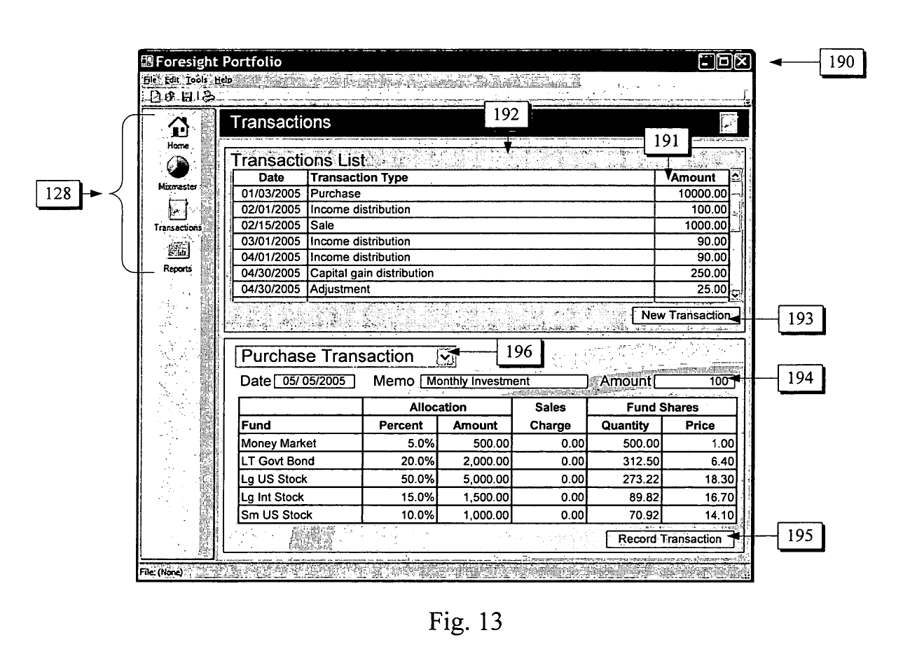

Optionally, a portfolio summary screen 180 in FIG. 13 may be employed to provide the user with a summary of the funds 184, asset classes 186 and weight percents 188 selected in a given investment mix, which are preferably displayed in a sub-display panel 182.

The foregoing describes the process and system for investment mix and portfolio creation, investment mix selection and interactive display of risk and return, recovery periods and efficient frontier for the investment mix or portfolio based upon historical data for the selected asset classes and investment mixes. However, in addition to merely providing predictive information based upon historical data, the present invention also provides for entry, tracking and forecasting of investment data and performance data for a user's actual investments.

Thus, once a user has selected a desired investment mix, the next step is to populate the portfolio with live data from the user's investment funds. A user may transfer existing account balance information into a new portfolio by either manual entry or via electronic transfer of the information into the inventive system. If the new portfolio is with the same fund company as his current account, then the user's existing funds will be liquidated and their balances transferred to the new funds selected by the user. If the user's existing funds are with a different fund company or companies, then the existing funds will be liquidated and the proceeds transferred to the new fund company.

New accounts may be created and entered into the inventive system as described above. Information pertaining to the new accounts may include basic information about the fund company, e.g., name, address, account number, etc, and the amount of money being transferred into the account or the current balance and distribution of funds maintained with the fund company. Once the user's balance with the fund company is entered, the system reads the user's selected portfolio in the inventive system and calculates the amount to be allocated to each fund to maintain the relative weights of each fund on the portfolio. These weights are referred to as the asset allocation of the portfolio. The user is preferably given the option of printing out a letter of instructions to mail or fax to the find company, or a checklist to use on the phone with their representatives. When the user has entered all information needed, the information is entered by the user selecting an appropriate entry button presented on the data entry screen, whereupon the data is recorded into the appropriate account register or file.

When the user creates a new account, an internal account register is preferably used to track the account. In accordance with the best mode for practicing the invention, the account register is saved in XML or Microsoft Access file format and read into memory as a Microsoft .Net dataset. If the user opens the account creation form on an account that has already been set up, a warning is presented to the user that entry of new account information with overwrite and delete the existing account register. If the user proceeds, the system will preferably automatically back up the current account register before overwriting the same.

As illustrated in FIG. 14, a transaction entry screen 190 may be selected by a user selecting a Transactions icon on selection panel 128. Once the initial Transactions screen 190 is displayed, the user is presented with a first sub-display panel 192 which provides a list of recent transactions for the user's portfolio, with each transaction line 191 having a transaction date, transaction type and transaction amount field. A new transaction is created by the user selecting the New Transaction icon 193, and then in a second sub-display panel 194, selecting a transaction type from a drop-down box 196 which contains a look-up table of transaction types, including, for example purchase transaction, sale transaction, income distribution, capital gain distribution, adjustment, portfolio revaluation, or rebalancing transaction, each of which is contemplated in accordance with the best mode for the present invention.

The first transactions in any portfolio are purchases. Accordingly, the present invention provides a purchase transaction sub-display panel 194 of the transaction entry screen 190. When a purchase transaction is selected, the user is prompted for entry of various data including, without limitation, the purchase transaction date, a descriptor of the purchase transaction, such as a monthly deposit, and the amount of the purchase transaction. The system then automatically allocates the purchase transaction amount across the selected investment portfolio in accordance with the weight percent of each asset class and fund as previously designated by the user, and displays the fund, the allocation, in both percent and amount, and permits the user to enter any sales charge information, quantity and price information the user wishes to track. The system of the present invention automatically calculates the optimal allocation of deposits to the funds in a portfolio, dynamically allocates deposits to the individual funds in the portfolio taking into account the user-specified weights for each fund and asset class.

After the initial purchase transactions are made when the portfolio is created, other allocations of purchase transactions may differ from the target weights of the portfolio's asset allocation. For example, large-cap US stocks may comprise 40% of the asset allocation, but the system's deposit calculation may allocate nothing to a portfolio's large-cap US stock fund. The reason has to do with rebalancing, the process of bringing a portfolio's actual asset allocation back into line with its target asset allocation. The movement of investment markets over time causes drift in a portfolio's asset allocation. That's because some asset classes increase in value, while others decrease or increase at a different rate. An investor periodically needs to rebalance a portfolio by transferring just enough among its funds to correct for this drift. Rebalancing frequency can be reduced by allocating deposits against the drift of a portfolio. For example, if a large-cap US stock fund has grown to the point of causing portfolio drift, then the investor should allocate a smaller portion of a deposit to that fund, and more to the funds that have not grown as much. This dynamic allocation of deposits can partially correct for portfolio drift and defer the need for rebalancing. The rebalancing process and system entry screens will be discussed in more detail below.

Sale or withdrawal events are made in a manner similar to purchases. From the sales transaction screen 200, the user selects a sale transaction from drop-down box 204 in sub-display panel 202, and then enters the transaction date, an amount, and a description. The system then dynamically calculates the sale or withdrawal amount for each fund and asset class in the user's portfolio and allocates according to the weight percentages designated by the user for each asset class and fund. The system displays the fund 206, the allocation 208, any applicable sales charges 207 and permits the user to quantity and price information 209. The transaction is entered by selecting the “record transaction” icon 195 which records the transaction to the account register.

Investments generate either as income (dividend) distributions or capital gains distributions. As the funds make such distributions and the user receives the monthly or quarterly account statements, the information should be entered into the system of the present invention using either an income distribution screen 210 in FIG. 16 or a capital gain distribution screen 220 in FIG. 17. Each of these screens includes a first sub-display panel 192, which includes the transactions list for the user, and a transaction entry icon 193 to permit the user to enter a new transaction. For an income distribution on screen 210, the user selects an income distribution transaction from drop-down screen 214, and is presented with an income distribution sub-display panel 212, into which the user is prompted to enter the transaction date, the fund from which the distribution is made 215, which preferably consists of a drop-down menu linked to the pre-selected funds from the user's portfolio to permit the user to select the fund by a point and click method, and the amount of the distribution 216. The user is also prompted at prompt 218 to specify whether the distribution was either automatically reinvested, in which case, the user is prompted to enter the price and number of shares of the reinvestment, or whether the income was distributed in cash. Once the transaction data is entered, the user records the transaction by selecting the “record transaction” icon 195 which records the transaction to the account register.

A capital gain distribution is entered in exactly the same manner as an income distribution, except that the entry is made by selecting a capital gain distribution transaction from drop-down selector 224, which then permits the user to enter the transaction date 223, fund descriptor, preferably from a drop-down selector 225 which is linked to the user's pre-selected funds from the portfolio and selected by a point and click method, and the amount of the capital gain distribution 226. Like the income distribution screen 210, the user is also prompted at prompt 227 to specify whether the distribution was either automatically reinvested, in which case, the user is prompted to enter the price and number of shares of the reinvestment, or whether the income was distributed in cash. Once the transaction data is entered, the user records the transaction by selecting the “record transaction” icon 195 which records the transaction to the account register.

Adjustment transactions may be entered on screen 230, in which an adjustment transaction type is selected from drop-down selector 234 on sub-display panel 192, and the user is prompted to enter information into a date field 233, a memorandum or descriptor field 231, an adjustment amount field 236, then to select the fund from a drop-down fund selector 235 which in which funds are read from the user-selected funds within each asset class selected at portfolio set up, then to enter the adjustment type by selecting from adjustment selector 237, which permits the user to select from adjustments, for example, tax basis, transaction amount correction or to update a transaction amount. Once the adjustment transaction data is entered, the user records the transaction by selecting the “record transaction” icon 195 which records the transaction to the account register.

The present invention needs to know month-end closing balances of each fund in a user's portfolio. The program uses these balances to calculate performance evaluation results, and to assess the need for rebalancing. In order to achieve this, the system includes a portfolio revaluation screen 240 in FIG. 19, which permits the user to select a portfolio revaluation transaction from a drop-down selector 244, and display a revaluation screen in sub-display panel 242. The revaluation screen 240 preferably includes a date filed 243, a memo or other descriptor field 245, an amount field 246 into which the user may enter the appropriate data. The individual funds 245 are also displayed, with entry fields for each fluid for user entry of quantity and price information 247. The system then computes fund value and displays the same on the basis of the quantity and price calculation in field 248. Asset allocations are then calculated and displayed 249, with both target weight percent, actual weight percent and differential percentages being calculated and displayed. Once the reevaluation transaction data is entered, the user records the transaction by selecting the “record transaction” icon 195 which records the transaction to the account register.

Finally, the inventive system provides a rebalancing transaction screen 250, in which the user may select a rebalancing transaction from drop-down transaction selector 254 in sub-display panel 252. The inventive system preferably suggests rebalancing any time the actual asset allocation of the portfolio deviates from its target asset allocation by more than 10% in any single fund. The user can change the threshold amount to a greater or lesser amount by setting a user option. Upon selecting a rebalancing transaction, the user is then prompted to enter the transaction date 252 and is presented with a listing of funds 255 in the portfolio, both the target and actual weight percentages 259 which are read from the user input weight percents for each asset class at portfolio set up, and from the drifted percentages due to actual growth or loss within each asset class. The system then permits the user to enter balancing transactions between funds or asset classes in order to adjust the weight percentages of each asset classes to the target weight percents originally established during the risk-return tolerance review during portfolio set up. Once the rebalancing transaction data is entered, the user records the transaction by selecting the “record transaction” icon 195 which records the transaction to the account register.

As we discussed above, most investment professionals recommend rebalancing a portfolio periodically to correct for drift. As the various markets move, some asset classes will grow past their target asset allocations, while others will shrink below their targets. Rebalancing involves withdrawing enough from the winning asset classes to bring them back to their target allocations, and depositing the proceeds to the losing asset classes, which will bring them back to their target allocations. Individual investors tend to find this advice counter-intuitive, and many resist the idea of rebalancing. For this reason, the present invention gives the user the option to turn rebalancing off if they don't want to do it. However, there are two proven benefits to rebalancing: (a) Rebalanced portfolios retain steady risk characteristics over time, while non-rebalanced portfolios tend to drift in the direction of greater risk; (b) Rebalanced portfolios tend to perform better than portfolios that are not rebalanced.

It is generally recommended that an investor review the performance of a portfolio on a quarterly basis. Thus, the system of the present invention is preferably set to run default quarterly performance reports based upon the user's selected portfolio funds. These reports may be set to run automatically on a calendar year quarter and be notated on the Calendar associated with the system. In order for a user to generate a report, the reports screen 260 in FIG. 21 is accessed by selecting the “Reports” icon on the navigation panel 128. The reports screen 260, like other screens in the inventive system, consists of a first sub-display panel 262 and a second sub-display panel 268. A report list 264 is presented in the first sub-display panel 262. A wide variety of reports as are known to those of ordinary skill in the art are available and presented for the user to select from report list 264 which may be scrolled through by the user. Reports include transactions during a user-specified period, portfolio composition over time, income distributions during the tax year, capital gain distributions during the tax year, and the like.

The present invention offers several more advanced portfolio reports for sophisticated investors. The first is a report that calculates risk-adjusted returns for both the portfolio and its benchmark, so the user can compare risk-adjusted performance over time. This report would be of limited interest to the user who has selected funds that best represent their asset classes. But it would be quite useful to an investor who has selected actively-managed funds on the expectation that they would provide returns over and above those attributable to the asset class. This report will enable such an investor to see how much return is attributable to value added by the manager, and how much is attributed to the mere assumption of additional risk by the manager.

Another more advanced report shows the performance of each individual fund in the portfolio against its individual benchmark. We refer to this as an advanced report only because we encourage users to take a portfolio view of their investments, rather than a fund-by-fund view. An investor who selects funds that best represent their asset classes would probably find little of interest in such a report, since each fund would be expected to mirror its asset class very closely. This report is included for those investors who choose their funds on other criteria, and for those who simply want a detailed, fund-by-fund view. Other customary financial reports, such as transaction lists, transactions by transaction type, etc. are permitted as are well known in the art.

Once the user has selected a report, a small form (not shown) appears at the top of the panel to collect any information needed to generate the report. For example, in order to print a performance report, the user would need to enter the beginning and ending date for the report, whereupon the report may be generated and previews the report in the second sub-display panel 268. The report is capable of being printed via the standard Microsoft WINDOWS File-Print command structure. A typical performance report may consist of two line graphs that represent the portfolio's performance against its benchmark. A first graph shows the return of the portfolio against its benchmark, and a second graph shows the risk of the portfolio compared to the same benchmark. In both reports, the lines for the portfolio and its benchmarks should be very close (within 15-20 basis points), assuming the user has selected funds that best represent their asset classes.

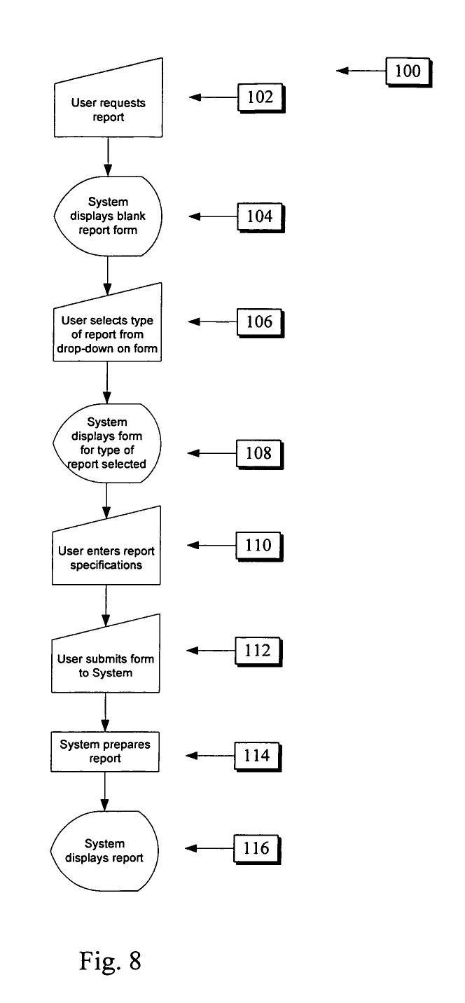

Transaction reporting display 100 generally proceeds in accordance with the flow diagram in FIG. 8. As described above, the user enters the reports module of the system at step 102, and from a blank report form presented at step 104, selects a report at step 106, typically from a drop-down selector containing a report list. In response to the user's selection in step 106, the system reads the selected file from the computer storage and loads it to the display in step 108. The selected report from prompts the user to enter report specifications, such as date range, transaction types, etc. in step 110, and the user submits the report request to the computer system at step 112. Based upon the user specifications and the selected report form, the system reads the relevant files from the computer storage and prepares the report at step 114 for display to the user at step 116.

Among the performance reports which the system is capable of generating, there are included the following: the time-weighted rate of return for the portfolio; a comparison between the portfolio's return to a weighted composite benchmark made up of market indexes for the asset classes in the portfolio. The inventive system calculates a current performance report, and it calculates performance for the current year and for the previous 3, 5, and 10 years, to the inception of the portfolio. The weighted composite benchmark is widely used in institutional investing, but not often used in retail investing. The benchmark is calculated as follows: First, indexes are selected to be used as benchmarks for each fund in the portfolio. The index selected is the one most representative of the asset class that the fund represents. For example, 30-day T-bills are used as the cash index, The S&P 500 index is used as the large US stock index, and the Morgan Stanley EAFE index is used as the index for large foreign stocks. The indexes, asset classes, fund descriptors and fund rankings are maintained by on a remote server, preferably accessible via the Internet, and available to users of the system either for electronic download or via electronic media such as CD-ROM. The asset class with which each index is identified is preset, so the user does not need to determine which index goes with which asset class. The individual fund indexes are used to benchmark the performance of each fund in the portfolio. Performance is reported using a simple line chart with a line for the fund and a line for the index. However, the indexes are also use to calculate a weighted composite index. Each index is given the same weight as its asset class in the portfolio, and the weighted indexes are summed to produce a benchmark for the portfolio. The results are presented on a line chart with a line for the benchmark and a line for the portfolio. Reports can be printed in the normal manner for a Windows program; i.e., by selecting the usual file-print command structure. Reports can be grouped, so that a set of reports can be viewed and printed by selecting the group. When reports are grouped, each report appears on a separate tabbed page on the second sub-display panel.

While the invention has been described with reference to its preferred embodiments, those of ordinary skill in the art will understand and appreciate that variations on screen display formats, screen display orders, command structures, data fields, field descriptors or the like are contemplated and within the scope of the invention., which is to be limited only by the claims appended hereto.

What is claimed is:

1. A computer-implemented method for graphically representing risk-return investment evaluations, comprising the steps of:
a) Presenting a plurality of pre-defined asset classes to a user and prompting the user to select at least one of the plurality of pre-defined asset classes;
b) Based the user selection of at least one of the plurality of pre-defined asset classes, reading historical risk and return data for each of the user-selected asset classes; and
c) Displaying on an electronic display, a risk and return graph for the user-selected asset classes over a period of time.

2. The method of claim 1, further comprising the step (d) of graphically displaying on the electronic display a mean recovery period for calculated loses based upon the greatest percentage of historical risk read from the historical risk data at a calculated mean historical return over the user selected time period.

3. The method of claim 1, wherein step a) further comprises the step of prompting a user to select an investment portfolio based upon the user's level of risk tolerance.

4. The method of claim 3, further comprising the step of providing an active selection icon on a graphical display corresponding to a level of risk tolerance.

5. The method of claim 1, further comprising the steps of:
a) Displaying to a user a pre-defined grouping of asset classes and querying the user to select at least one of the plurality of asset classes for the user's portfolio;
b) Prompting the user to assign a desired weight percent as a basis of the total portfolio to each of the asset classes selected from the plurality of asset classes;
c) Applying Markowitz-Todd algorithm in a mean variance optimization computation based upon the user's selected asset classes, weight percent and benchmark historical data for the selected asset classes; and
d) Displaying the output of the mean variance optimization computation on the risk and return graph.

6. The method of claim 5, wherein step c) further comprises the steps of calculating a plurality of corner investment mixes and interpolating from the plurality of investment mixes a larger number of investment mixes for the user selected asset classes.

7. The method of claim 5, further comprising the step of calculating an efficient frontier for the user-selected portfolio and displaying a point corresponding to the computed risk and return for a user selected investment mix.
